(19) United States
(12) Patent Application Publication
(10) Pub. No.: US 2004/0156520 A1
(43) Pub. Date: Aug. 12, 2004

(54) Miniature digital transducer with reduced number of external terminals

(76) Inventors: Jens Kristian Poulsen, Hedehusene (DK); Henrik Thomsen, Soborg (DK); Jozef Johannes Gerardus Bosch, Amsterdam (NL)

Correspondence Address: HARNESS, DICKEY & PIERCE, P.L.C., P.O. BOX 8910, RESTON, VA, 20195, US

(21) Appl. No.: 10/410,163

(22) Filed: Apr. 10, 2003

Related U.S. Application Data
(60) Provisional application No. 60/371,138, filed on Apr. 10, 2002.
(60) Provisional application No. 60/416,529, filed on Oct. 8, 2002.

(51) Int. Cl. H04R 17/02; H04R 9/08; H04R 21/02

(52) U.S. Cl. 381/369; 381/314; 381/312

(57) ABSTRACT

The present invention relates to miniature transducer assemblies arranged within an assembly housing having a plurality of external terminals on the assembly housing in order for the assembly to be able to receive and transmit electrical signals to and from the assembly, wherein at least one of the plurality of external terminals is adapted to receive and/or transmit at least two electrical signals so as to reduced the number of external terminals on the assembly housing. The principles apply, for example, to miniature microphone or telecoil assemblies having built-in analog-to-digital converters so as to be able to provide a digital output signal according to a sensed acoustic pressure.

The present invention relates to a miniature transducer assemblies—e.g. digital miniature microphone assemblies—having a reduced number of external terminals. In particular, the present invention relates to a digital miniature transducer assembly where at least one external terminal is adapted to handle at least two electrical signals, such as receiving and/or transmitting.

### BACKGROUND OF THE INVENTION

Within a large variety of miniature applications such as mobile communication devices and hearing aids, digital signal processing has become widespread. However, a miniature transducer typically used within such applications generates by nature an analog electrical signal. Therefore, many modern miniature transducer assemblies have an integrated analog-to-digital converter positioned within their housing so as to convert an analog electrical signal from a transducer to a digital electrical signal which is made externally available for connection to an application. In this way an analog electrical signal from the transducer is converted into a digital electrical signal very early in the signal processing path so that the sensitive analog signal path is reduced to a minimum. Since the analog signal path is positioned within the transducer assembly housing it can be effectively shielded against external electro-magnetic interference (EMI). An output signal from such a miniature transducer assembly is provided as a digital electrical signal which is much more robust against EMI. Therefore, compared to a miniature transducer assembly providing an analog output signal a digital miniature transducer assembly is less sensitive to EMI and furthermore, the number of system components is reduced in such an assembly. An example of a miniature transducer assembly according to the above-mentioned description is electro-acoustic transducer assemblies such as a miniature microphone assembly for mobile phones or hearing aids.

Due to the widespread digital signal processing within many miniature applications there are also miniature transducer assemblies adapted to receive a digital electrical input signal. Such miniature transducers convert the received digital signal with a digital-to-analog converter positioned within the miniature transducer assembly housing. A resulting analog electrical signal can then be applied to a transducer which is adapted to produce e.g. an audio output signal in the form of a wave. Examples of such miniature transducer assemblies are electro-acoustic transducers such as receivers for a hearing aids or speakers for mobile phones.

In order for the mentioned digital miniature transducer assemblies to be able to operate, a power source, a clock circuit and a data connection to the outside world are required. The clock circuit may reside inside the transducer or it may be an externally supplied signal. The power is supplied by the outside world and output data are transmitted in or out of the transducer.

Thus, two traditional implementations exist—namely:

1) A conventional digital miniature transducer assembly—here exemplified by a microphone assembly (see FIG. 1a)—may be implemented with four terminals (ground, power, data and clock). This type of microphone requires an externally generated clock signal.

2) Alternatively, a conventional digital miniature transducer assembly (see FIG. 1b) may have a total of three terminals (ground, power and data). This solution requires an internal clock circuit inside the transducer assembly.

Thus, a minimum of three terminals are required no matter which conventional transducer assembly is chosen. These three terminals require a certain amount of space which may be problematic in some areas of application—such as within the field of low cost consumer applications and space constrained systems like hearing aids. Furthermore, several terminals may complicate the assembling of the transducer assembly. In addition, mounting and connection of the transducer assembly within an given application is also more costly if several terminals are to be connected to the application.

### SUMMARY OF THE INVENTION

It is an object of the present invention to provide a new implementation of a digital miniature transducer assembly having a reduced number of external terminals on the transducer housing in order to minimize production and manufacturing and assembly costs. The principles behind the present invention apply to all types of digital miniature transducer assemblies—such as to microphone assemblies, magnetic sensing devices (tele-coils), telephone- or hearing aid receivers, small speakers etc.

A consequence of having a reduced number of external terminals is also that the overall size of the miniature transducer assembly may be reduced which is an important issue within some specific applications of such miniature transducer assemblies. Thus, it may be of major importance that miniature transducer assemblies can be manufactured with a reduced number of terminals in order to save space, and, at the same time, keeping the manufacturing and assembly costs at a minimum level.

The above-mentioned objects are complied with by combining a power and clock signal on the same terminal. It can also be achieved using a combination of a data and clock signal on the same terminal, a combination of data, clock and power on the same terminal and variations hereof. Also, the ground terminal may be used in a combination with either data or clock signals. Furthermore, when using a combination of data and clock signals, the data may be separated from the clock signal using voltage driving of the clock signal and current signaling on the data signal, or by the use of time-multiplexing of these signals. In this configuration both signals are using voltage-drivers, which minimizes current consumption and increases noise immunity.

In a first aspect, the present invention relates to a miniature transducer assembly comprising a digital transducer arranged in a transducer assembly housing,

wherein the digital transducer comprises

a transducer element for converting changes of a physical parameter into analog electrical signals,

an analog-to-digital converter having an input and an output terminal, the analog-to-digital converter being adapted to receive, on its input terminal, analog electrical signals, and convert the received analog electrical signals to digital electrical signals,

the miniature transducer assembly further comprising a plurality of external terminals on the transducer assembly housing in order for the miniature transducer assembly to be able to receive and transmit electrical signals to and from the miniature transducer assembly, wherein at least one of the plurality of external terminals is adapted to receive and/or transmit at least two electrical signals so as to reduce the number of external terminals on the miniature transducer assembly.

By a change in a physical parameter is understood a change in a parameter of a transmission medium that can be sensed by the transducer element. It may be a change in air pressure such as produced by an acoustical wave propagating through the air. It may also be a change in electromagnetic energy such as produced by electromagnetic waves propagating in air. It may also be changes in position such as produced by vibration waves propagating in a solid or partly solid medium.

The miniature transducer assembly may comprise two external terminals. In one embodiment a first external terminal is adapted to be connected to ground, and a second external terminal is adapted to receive a power supply signal and to provide a data signal from the miniature transducer assembly, the data signal comprising the digital electrical signals. In another embodiment a first external terminal is adapted to be connected to ground, and a second external terminal is adapted to receive an externally generated clock signal, and to provide a data signal from the miniature transducer assembly, the data signal comprising the digital electrical signals. The miniature transducer assembly may further comprise means for generating, from the externally generated clock signal provided on the second external terminal, a power supply signal for powering the miniature transducer assembly.

The miniature transducer assembly may further comprise means for generating a clock signal.

The miniature transducer assembly may comprise three external terminals. In one embodiment a first external terminal is adapted to be connected to ground, and a second external terminal is adapted to receive an externally generated clock signal, and wherein a third external terminal is adapted to provide a data signal from the miniature transducer assembly, the data signal comprising the digital electrical signals. In another embodiment the miniature transducer assembly further comprises means for generating, from the externally generated clock signal provided on the second external terminal, a power supply signal for powering the miniature transducer assembly.

The analog-to-digital converter may further comprise a pre-amplifier monolithically integrated with the analog-to-digital converter. The monolithically integrated pre-amplifier is positioned in a signal path between the transducer element and the analog-to-digital converter.

The transducer element may be a microphone adapted to receive acoustic pressure waves, and for converting the received acoustic pressure waves to analog electrical signals.

The transducer element may be a telecoil adapted to receive electromagnetic waves, and for converting the received electromagnetic waves to analog electrical signals.

The externally generated clock signal and the data signal may be time multiplexed. When the clock signal is logic high, the data signal may be inactive, and wherein, when the clock signal is logic low, the clock signal generator generating the clock signal may be disabled. The level of the clock signal, when it is in its high logic state, may be substantially equal to the level of a power supply signal. The level of the data signal, when it is in its high logic state, may be substantially equal to half of the level of a power supply signal.

In a second aspect, the present invention relates to a miniature transducer assembly comprising a digital transducer arranged in a transducer assembly housing,

wherein the digital transducer comprises

a transducer element for converting changes of a physical parameter into analog electrical signals, and

an analog-to-digital converter having an input and an output terminal, the analog-to-digital converter being adapted to receive, on the input terminal, analog electrical signals, and convert the received analog electrical signals to digital electrical signals,

the miniature transducer assembly further comprising a first and a second external terminal on the transducer assembly housing, the first external terminal being adapted to receive a first electrical signal, the second external terminal being adapted to receive a second and different electrical signal, the miniature transducer assembly further comprising means for generating, from the first or the second electrical signal, a third and different electrical signal.

The first electrical signal may be an externally generated clock signal, and the second “electrical signal” is ground. Thus, the second external terminal is connected to ground (0 Volts).

The generating means for generating the third and different electrical signal may comprise rectifier means, such as a diode, and a capacitor. The third and different signal may be generated from the externally generated clock signal. The generated third electrical signal may power the miniature transducer assembly.

The miniature transducer assembly may further comprise means for generating a fourth electrical signal in response to determined current consumption variations of the miniature transducer assembly. The fourth electrical signal may be associated with the digital electrical signals from the analog-to-digital converter. Thus, the fourth electrical signal reflects variations in power consumption of the assembly which again is a measure of the digital electrical signal. The generating means for generating the fourth electrical signal may comprise current sensing means and a data load resistor.

The current sensing means may comprise a resistor and a capacitor, the resistor and the capacitor being connected in parallel.

In a first embodiment, the current sensing means is connected to the first external terminal so as to receive an externally generated clock signal. The data load resistor is connected between the second external terminal and the output terminal of the analog-to-digital converter.

In a second embodiment, the current sensing means is connected to the first external terminal so as to receive an externally generated clock signal. Here, the data load resistor is connected between the first external terminal and the output terminal of the analog-to-digital converter.

In a third embodiment, the current sensing means is connected between the second external terminal and ground. Here, the data load resistor is connected between the second external terminal and the output terminal of the analog-to-digital converter.

In a fourth embodiment, the current sensing means is connected between the second external terminal and ground. Here, the data load resistor is connected between the first external terminal and the output terminal of the analog-to-digital converter.

The analog-to-digital converter may further comprise a pre-amplifier monolithically integrated with the analog-to-digital converter. The monolithically integrated pre-amplifier may be positioned in a signal path between the transducer element and the analog-to-digital converter.

The transducer element may be a microphone adapted to receive acoustic pressure waves, and for converting the received acoustic pressure waves to analog electrical signals.

The transducer element may be a digital telecoil adapted to receive electromagnetic waves, and for converting the received electromagnetic waves to analog electrical signals.

In a third aspect, the present invention relates to a miniature transducer assembly comprising a digital transducer arranged in a transducer assembly housing,

wherein the digital transducer comprises

a digital-to-analog converter having an input and an output terminal, the digital-to-analog converter being adapted to receive, on its input terminal, digital electrical signals, and convert the received digital electrical signals to analog electrical signals,

a transducer element for receiving the analog electrical signals, and for converting the received analog electrical signals to mechanical movements of at least part of the transducer element,

the transducer assembly further comprising a plurality of external terminals on the transducer assembly housing in order for the transducer assembly to be able to receive and transmit electrical signals to and from the transducer assembly, wherein at least one of the plurality of external terminals is adapted to receive and/or transmit at least two electrical signals so as to reduce the number of external terminals on the transducer assembly.

The miniature transducer assembly may comprise two external terminals. The miniature transducer assembly may further comprise means for generating a clock signal.

A first external terminal may be adapted to be connected to ground, and a second external terminal may be adapted to receive a power supply signal and to provide a data signal to the miniature transducer assembly, the data signal comprising the digital electrical signals.

A first external terminal may be adapted to be connected to ground, and a second external terminal may be adapted to receive an externally generated clock signal, and to provide a data signal to the miniature transducer assembly, the data signal comprising the digital electrical signals.

The miniature transducer assembly may further comprise means for generating, from the externally generated clock signal provided on the second external terminal, a power supply signal for powering the miniature transducer assembly.

The miniature transducer assembly may comprise three external terminals. A first external terminal may be adapted to be connected to ground, and a second external terminal may be adapted to receive an externally generated clock signal, and a third external terminal may be adapted to provide a data signal to the miniature transducer assembly, the data signal comprising the digital electrical signals.

The miniature transducer assembly may further comprise means for generating, from the externally generated clock signal provided on the second external terminal, a power supply signal for powering the miniature transducer assembly.

The externally generated clock signal and the data signal may be time multiplexed. In one embodiment the clock signal is logic high, the data signal is inactive, and wherein, when the clock signal is logic low, the clock signal generator generating the clock signal is disabled. In another embodiment the level of the clock signal, when it is in its high logic state, is substantially equal to the level of a power supply signal. In still another embodiment the level of the data signal, when it is in its high logic state, is substantially equal to half of the level of a power supply signal.

The miniature transducer assembly may be a receiver suitable for integration in a hearing aid. The miniature transducer assembly may also be a speaker suitable for integration in a cellular phone.

In a fourth aspect, the present invention relates to a miniature transducer assembly comprising a digital transducer arranged in a transducer assembly housing,

wherein the digital transducer comprises

a digital-to-analog converter having an input and an output terminal, the digital-to-analog converter being adapted to receive, on its input terminal, digital electrical signals, and convert the received digital electrical signals to analog electrical signals,

a transducer element for receiving the analog electrical signals, and for converting the received analog electrical signals to mechanical movements of at least part of the transducer element,

the transducer assembly further comprising a first and a second external terminal on the transducer assembly housing, the first external terminal being adapted to receive a first electrical signal, the second external terminal being adapted to receive a second and different electrical signal, the transducer assembly further comprising means for generating, from the first or the second electrical signal, a third and different electrical signal.

The first electrical signal may be an externally generated clock signal, and the second electrical signal may be ground.

The generating means for generating the third and different electrical signal may comprise rectifier means and a capacitor, and the third and different signal may be generated from the externally generated clock signal. The rectifier means may comprise a diode.

The generated third electrical signal may power the miniature transducer assembly.

The miniature transducer assembly may further comprise means for generating a fourth electrical signal in response to determined current consumption variations of the miniature transducer assembly. The fourth electrical signal may be associated with the digital electrical signals to the digital-to-analog converter.

The generating means for generating the fourth electrical signal may comprise current sensing means and a data load resistor. The current sensing means may comprise a resistor and a capacitor, the resistor and the capacitor being connected in parallel. The current sensing means may be connected to the first external terminal so as to receive an externally generated clock signal, and the data load resistor may be connected between the second external terminal and the input terminal of the digital-to-analog converter.

Alternative, the current sensing means may be connected to the first external terminal so as to receive an externally generated clock signal, and the data load resistor may be connected between the first external terminal and the input terminal of the digital-to-analog converter. The current sensing means may also be connected between the second external terminal and ground, and the data load resistor may be connected between the second external terminal and the input terminal of the digital-to-analog converter. Finally, the current sensing means may be connected between the second external terminal and ground, and the data load resistor may be connected between the first external terminal and the input terminal of the digital-to-analog converter.

The miniature transducer assembly may be a receiver suitable for integration in a hearing aid. The miniature transducer assembly may also be a receiver suitable for integration in a cellular phone.

In a fifth aspect, the present invention relates to a miniature transducer assembly having a transducer assembly housing and comprising,

a transducer element,

an analog-to-digital converter having an input and an output terminal, the analog-to-digital converter being adapted to receive, on its input terminal, analog electrical signals from the transducer element, and convert the received analog electrical signals to digital electrical signals,

a digital-to-analog converter having an input and an output terminal, the digital-to-analog converter being adapted to receive, on its input terminal, digital electrical signals, and convert the received digital electrical signals to analog electrical signals, and provide the converted digital signals to the transducer element, the miniature transducer assembly further comprising a plurality of external terminals on the transducer assembly housing in order for the miniature transducer assembly to be able to receive and transmit electrical signals to and from the miniature transducer assembly, wherein at least one of the plurality of external terminals is adapted to receive and/or transmit at least two electrical signals so as to reduce the number of external terminals on the miniature transducer assembly.

The miniature transducer assembly may further comprise means for selectively switching between a first and a second mode of operation. In the first mode of operation, the transducer element may be connected to the analog-to-digital converter via the switching means so as to operate e.g. as a microphone. In the second mode of operation, the transducer element may be connected to the digital-to-analog converter via the switching means so as to operate e.g. as a speaker. Preferably, at least one of the plurality of external terminals is adapted to provide digital electrical signals both to and from the miniature transducer assembly.

### BRIEF DESCRIPTION OF THE DRAWINGS

The present invention will now be explained in further details with reference to the accompanying figures, where

FIG. 1 shows a conventional digital microphone having three or four external terminals,

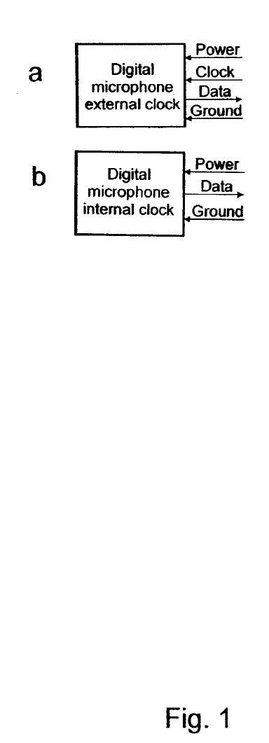

FIG. 2 shows different embodiments of the present invention,

FIG. 3 illustrates time-multiplexing of clock and data signals, and

FIG. 4 shows different embodiments of a two-terminal digital microphone.

While the invention is susceptible to various modifications and alternative forms, specific embodiments have been shown by way of example in the drawings and will be described in detail herein. It should be understood, however, that the invention is not intended to be limited to the particular forms disclosed. For example, even though the present invention will be described in detail with reference to digital microphones, it should be understood that the principles behind the present invention apply as well to other digital transducers—such as to magnetic sensing devices (telecoils), telephone—or hearing aid receivers, small speakers etc. Thus, the invention is to cover all modifications, equivalents, and alternatives falling within the spirit and scope of the invention as defined by the appended claims.

### DETAILED DESCRIPTION OF THE INVENTION

The present invention will now be explained with reference to digital microphones but as mentioned, the principles behind the present invention also apply to other miniature transducer assemblies with digital electrical outputs or digital electrical inputs.

The present invention uses a combination of electrical signals in order to reduce the number of terminals on digital microphones. By combining two or more signals into a single electrical signal it is possible to reduce the number of terminals on a digital microphone. The advantage of such a microphone is that the number of terminals on the microphone can be reduced whereby the overall size of the microphone can be reduced as well.

By combining e.g. three terminals into one it is possible to make a two-terminal digital microphone. This can be done by powering the digital microphone from an externally generated clock input signal while at the same time transmitting data by changing the current consumption of the two-terminal digital microphone. Thus, two different data output states will result in two different levels of supply currents. This will be explained in further details below.

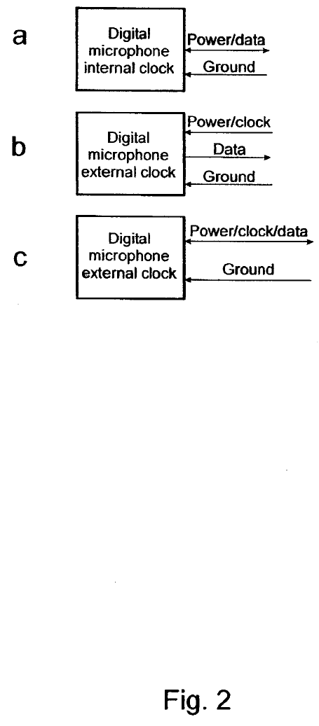

Referring now to FIG. 2, three different embodiments are shown. In FIG. 2a, a two-terminal digital microphone with internal clock generator is depicted. In this embodiment, the power and data terminal are combined on the same terminal. The second terminal is connected to ground. The combination of two electrical signals going in opposite directions (e.g. power and data) can be accomplished using a voltage driver in one end and a current driver in the other end. Thus, a combination of “power in” and “data out” can be implemented by adding an extra load to the power line to signal a different logical state, and then measuring the current in the combined connection.

In FIG. 2b, a digital microphone with three terminals is depicted. In contrast to the microphone of FIG. 2a, this digital microphone is assumed to require an externally generated clock signal in order to operate. As seen, one terminal is connected to ground, another terminal (middle terminal) is adapted to provide the outgoing data signal to the surroundings, whereas the last terminal (upper terminal) is a combined power and clock signal terminal. Preferably, the digital microphone of FIG. 2b is powered from the provided clock signal. As explained later, this may be achieved by placing an electrical rectifier inside the microphone, which separates the clock input signal and power input signal. Even further, due to the high frequency of the clock signal, an electronic filter with small physical dimensions may be arranged on the digital microphone chip.

For example, a diode (standard Silicon, Germanium, pn-junction or Schottky type) or a low-drop rectifier using a transistor may be applied to rectify the clock signal. A low pass filter removes the high frequency component originating of the clock signal. The remaining signal may be used to power the digital microphone.

A digital microphone as shown in FIG. 2b may be operated with clock signal frequency of 1.024 MHz and a VDD of 2.0 V. A signal-to-noise ratio of 80 dB has been achieved.

In FIG. 2c, a two-terminal digital microphone with combined power, clock signal and data terminal is depicted. This two-terminal embodiment requires that an externally generated clock signal be provided to the upper terminal. The second terminal is connected to ground. Similar to the embodiment of FIG. 2b, the clock signal powers the digital microphone, and similar to the embodiment of FIG. 2a, the data signal is provided by adding a resistive load on the clock signal line.

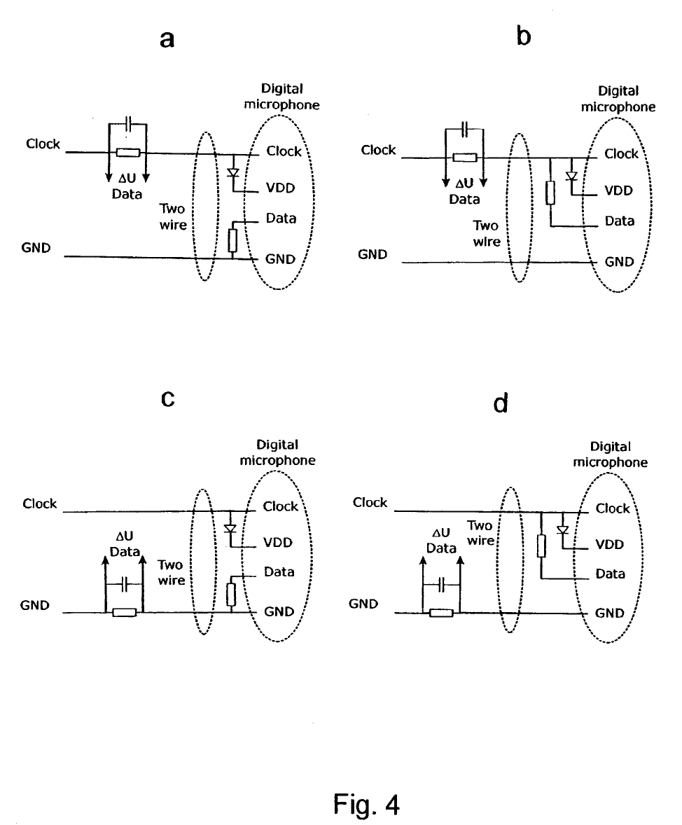

FIG. 4 shows four different embodiments of a two-terminal digital microphone. All shown embodiments require an external clock signal. In FIGS. 4a-d the following terminology is used:

Clock: Clock signal from an external clock source that is powerful enough to provide power the digital microphone.

GND: Ground terminal (0 Volt).

VDD: Power supply for the digital microphone (an internal capacitor in the digital microphone is needed for stabilising VDD).

Data: Data output terminal from digital microphone.

GND: Ground terminal for digital microphone.

The microphone assemblies of FIGS. 4a-d are, preferably, entirely encapsulated in a microphone assembly housing which shields the digital microphone against undesired high frequency EMI. The microphone assembly housing is preferably composed of an electrically conducting material, such as steel or aluminum, or metallized non-conductive materials, such as metal particle-coated plastics

Referring now to FIGS. 4a-d, due to the voltage drop over the current sensing circuit (parallel coupled resistor and capacitor), the VDD required is higher. This may be counteracted by including an internal voltage doubler in the digital microphone or by the use of more advanced current sensing circuits—for example a circuit that measures the supply current using a trans-impedance amplifier.

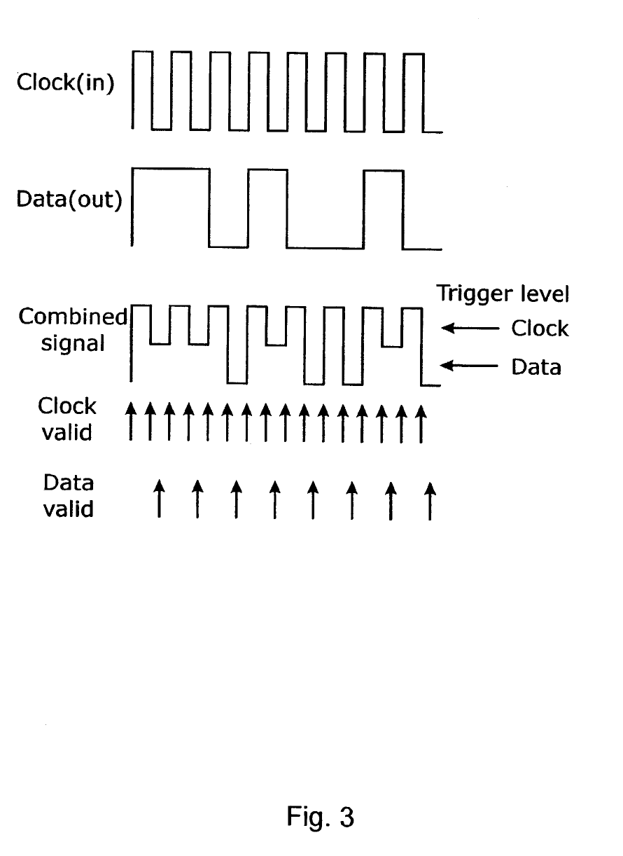

The differentiation of the data signal and the clock signal may, alternatively, be accomplished using time-multiplexing of these signal. When the clock signal is high, the data signal output is inactive (tri-state), and the level on the multiplexed clock and data line is determined by an external clock output driver. When the clock signal is low, the clock output driver is disabled and put into tri-state mode, while the data output now signals the information using two voltage levels. Each of these levels is distinct and different from the clock driver output signal when this signal is high. In this way, it is possible to extract the clock signal without the use of special circuits (e.g. using a PLL) and the data is signaled without the use of a higher current consumption—see FIG. 3. Thus, this signaling scheme can be used to make a two-terminal microphone, without increasing the current consumption. Also, this configuration will increase the noise immunity for a two-terminal digital microphone.

Typically, a high clock signal level equals the voltage level of VDD, whereas VDD/2 is used for a high data signal level, while ground is used for data low. This scheme will give maximum noise immunity when combined with trigger levels of ¾ VDD for clock detection and ¼ VDD for data detection circuits—see FIG. 3.

FIG. 4a shows a two-terminal digital microphone. The digital microphone itself comprises, as a minimum, a transducer and an analog-to-digital converter. The transducer may for example be a Si-based condenser microphone. In a preferred embodiment, the microphone comprises an electret assembly that includes a flexible diaphragm that moves in response to exposure to acoustical energy. The movement of the flexible diaphragm results in an electrical signal and, thus, the microphone converts the acoustical energy into electrical energy.

This electrical energy is provided as analog electrical audio signals to either a microphone pre-amplifier, which amplifies the analog electrical audio signals to an appropriate level for the analog-to-digital converter, or directly to the analog-to-digital converter. The optional pre-amplifier may include more than one gain stage. The analog-to-digital converter converts the analog electrical audio signals to digital electrical output signals. Alternatively, the analog-to-digital converter has an integrated pre-amplifier adapted to amplify an analog electrical audio signal before applying it to the analog-to-digital converter.

In a preferred embodiment, the analog-to-digital converter is implemented as a sigma-delta modulator, which converts the analog electrical audio signals into a serial digital electrical bit stream. Alternatively, the analog-to-digital converter may be, for example, a flash or pipeline converter, a successive approximation converter, or any other suitable analog-to-digital converter.

As seen in FIGS. 4a-b, the ground terminal of the microphone is connected directly to ground. A data load resistor is connected between ground and the data output terminal (output terminal of the analog-to-digital converter). The current sensing means is arranged in the clock signal line. A time varying voltage is generated over the parallel coupled resistor and capacitor in response to a time varying power consumption of the digital microphone.

The digital microphone is powered from the provided clock signal by use of a rectifier and a capacitor in order to low pass filter the generated VDD. When the data output is at a logic high level in FIG. 4a, the current consumption will be higher as compared to when the data output is logic low, due to the current drain through the resistor.

In FIG. 4b, the load resistor is positioned between the clock signal line and data output terminal. In this configuration, a low level output will result in a higher current consumption, whereas when the data output is at a logic high level, the power consumption will be lower.

Alternative embodiments are depicted in FIGS. 4c and 4d, where (in FIG. 4c) the current sensing means is positioned in the ground line, and where a load resistor is positioned between ground and the data output terminal. In FIG. 4d the data load resistor is positioned between the clock signal line and the data output terminal. As seen, the current sensing means is positioned in the ground line. The preferred configuration is determined by Data circuit characteristics.

The current sensing circuit may be implemented using a resistor of 390Ω and a capacitor having a capacitance of 100 pF. The data load resistor may be between 4.7 kΩ and 6.8 kΩ. The clock signal frequency may be 2.048 MHz, whereas VDD may be around 3 V. Under these circumstances a signal-to-noise ratio of 60-70 dB has been achieved. The data output voltage has been measured to 200-350 mVₚₚ.

1. A miniature transducer assembly comprising a digital transducer arranged in a transducer assembly housing,
wherein the digital transducer comprises
a transducer element for converting changes of a physical parameter into analog electrical signals,
an analog-to-digital converter having an input and an output terminal, the analog-to-digital converter being adapted to receive, on its input terminal, analog electrical signals, and convert the received analog electrical signals to digital electrical signals,
the miniature transducer assembly further comprising a plurality of external terminals on the transducer assembly housing in order for the miniature transducer assembly to be able to receive and transmit electrical signals to and from the miniature transducer assembly, wherein at least one of the plurality of external terminals is adapted to receive and/or transmit at least two electrical signals so as to reduce the number of external terminals on the miniature transducer assembly.

2. A miniature transducer assembly according to claim 1 comprising two external terminals.

3. A miniature transducer assembly according to claim 1, further comprising means for generating a clock signal.

4. A miniature transducer assembly according to claim 2, wherein a first external terminal is adapted to be connected to ground, and wherein a second external terminal is adapted to receive a power supply signal and to provide a data signal from the miniature transducer assembly, the data signal comprising the digital electrical signals.

5. A miniature transducer assembly according to claim 2, wherein a first external terminal is adapted to be connected to ground, and wherein a second external terminal is adapted to receive an externally generated clock signal, and to provide a data signal from the miniature transducer assembly, the data signal comprising the digital electrical signals.

6. A miniature transducer assembly according to claim 5, further comprising means for generating, from the externally generated clock signal provided on the second external terminal, a power supply signal for powering the miniature transducer assembly.

7. A miniature transducer assembly according to claim 1 comprising three external terminals.

8. A miniature transducer assembly according to claim 7, wherein a first external terminal is adapted to be connected to ground, and wherein a second external terminal is adapted to receive an externally generated clock signal, and wherein a third external terminal is adapted to provide a data signal from the miniature transducer assembly, the data signal comprising the digital electrical signals.

9. A miniature transducer assembly according to claim 8, further comprising means for generating, from the externally generated clock signal provided on the second external terminal, a power supply signal for powering the miniature transducer assembly.

10. A miniature transducer assembly according to claim 1, wherein the analog-to-digital converter further comprises a pre-amplifier monolithically integrated with the analog-to-digital converter.

11. A miniature transducer assembly according to claim 10, wherein the monolithically integrated pre-amplifier is positioned in a signal path between the transducer element and the analog-to-digital converter.

12. A miniature transducer assembly according to claim 1, wherein the transducer element is a microphone adapted to receive acoustic pressure waves, and for converting the received acoustic pressure waves to analog electrical signals.

13. A miniature transducer assembly according to claim 1, wherein the transducer element is a telecoil adapted to receive electromagnetic waves, and for converting the received electromagnetic waves to analog electrical signals.

14. A miniature transducer assembly according to claim 5, wherein the externally generated clock signal and the data signal are time multiplexed.

15. A miniature transducer assembly according to claim 14, wherein, when the clock signal is logic high, the data signal is inactive, and wherein, when the clock signal is logic low, the clock signal generator generating the clock signal is disabled.

16. A miniature transducer assembly according to claim 14, wherein the level of the clock signal, when it is in its high logic state, is substantially equal to the level of a power supply signal.

17. A miniature transducer assembly according to claim 14, wherein the level of the data signal, when it is in its high logic state, is substantially equal to half of the level of a power supply signal.

18. A miniature transducer assembly comprising a digital transducer arranged in a transducer assembly housing,
wherein the digital transducer comprises
a transducer element for converting changes of a physical parameter into analog electrical signals, and
an analog-to-digital converter having an input and an output terminal, the analog-to-digital converter being adapted to receive, on the input terminal, analog electrical signals, and convert the received analog electrical signals to digital electrical signals,
the miniature transducer assembly further comprising a first and a second external terminal on the transducer assembly housing, the first external terminal being adapted to receive a first electrical signal, the second external terminal being adapted to receive a second and different electrical signal, the miniature transducer assembly further comprising means for generating, from the first or the second electrical signal, a third and different electrical signal.

19. A miniature transducer assembly according to claim 18, wherein the first electrical signal is an externally generated clock signal, and wherein the second electrical signal is ground.

20. A miniature transducer assembly according to claim 19, wherein the generating means for generating the third and different electrical signal comprises rectifier means and a capacitor, and wherein the third and different signal is generated from the externally generated clock signal.

21. A miniature transducer assembly according to claim 20, wherein the rectifier means comprises a diode.

22. A miniature transducer assembly according to claim 18, wherein the generated third electrical signal powers the miniature transducer assembly.

23. A miniature transducer assembly according to claim 18, further comprising means for generating a fourth electrical signal in response to determined current consumption variations of the miniature transducer assembly.

24. A miniature transducer assembly according claim 23, wherein the fourth electrical signal is associated with the digital electrical signals from the analog-to-digital converter.

25. A miniature transducer assembly according to claim 23, wherein the generating means for generating the fourth electrical signal comprises current sensing means and a data load resistor.

26. A miniature transducer assembly according to claim 25, wherein the current sensing means comprises a resistor and a capacitor, the resistor and the capacitor being connected in parallel.

27. A miniature transducer assembly according to claim 25, wherein the current sensing means is connected to the first external terminal so as to receive an externally generated clock signal, and wherein the data load resistor is connected between the second external terminal and the output terminal of the analog-to-digital converter.

28. A miniature transducer assembly according to claim 25, wherein the current sensing means is connected to the first external terminal so as to receive an externally generated clock signal, and wherein the data load resistor is connected between the first external terminal and the output terminal of the analog-to-digital converter.

29. A miniature transducer assembly according to claim 25, wherein the current sensing means is connected between the second external terminal and ground, and wherein the data load resistor is connected between the second external terminal and the output terminal of the analog-to-digital converter.

30. A miniature transducer assembly according to claim 25, wherein the current sensing means is connected between the second external terminal and ground, and wherein the data load resistor is connected between the first external terminal and the output terminal of the analog-to-digital converter.

31. A miniature transducer assembly according to claim 18, wherein the analog-to-digital converter further comprises a pre-amplifier monolithically integrated with the analog-to-digital converter.

32. A miniature transducer assembly according to claim 31, wherein the monolithically integrated pre-amplifier is positioned in a signal path between the transducer element and the analog-to-digital converter.

33. A miniature transducer assembly according to claim 18, wherein the transducer element is a microphone adapted to receive acoustic pressure waves, and for converting the received acoustic pressure waves to analog electrical signals.

34. A miniature transducer assembly according to claim 18, wherein the transducer element is a digital telecoil adapted to receive electromagnetic waves, and for converting the received electromagnetic waves to analog electrical signals.

35. A miniature transducer assembly comprising a digital transducer arranged in a transducer assembly housing,
wherein the digital transducer comprises
a digital-to-analog converter having an input and an output terminal, the digital-to-analog converter being adapted to receive, on its input terminal, digital electrical signals, and convert the received digital electrical signals to analog electrical signals,
a transducer element for receiving the analog electrical signals, and for converting the received analog electrical signals to mechanical movements of at least part of the transducer element,
the transducer assembly further comprising a plurality of external terminals on the transducer assembly housing in order for the transducer assembly to be able to receive and transmit electrical signals to and from the transducer assembly, wherein at least one of the plurality of external terminals is adapted to receive and/or transmit at least two electrical signals so as to reduce the number of external terminals on the transducer assembly.

36. A miniature transducer assembly according to claim 35 comprising two external terminals.

37. A miniature transducer assembly according to claim 35, further comprising means for generating a clock signal.

38. A miniature transducer assembly according to claim 36, wherein a first external terminal is adapted to be connected to ground, and wherein a second external terminal is adapted to receive a power supply signal and to provide a data signal to the miniature transducer assembly, the data signal comprising the digital electrical signals.

39. A miniature transducer assembly according to claim 36, wherein a first external terminal is adapted to be connected to ground, and wherein a second external terminal is adapted to receive an externally generated clock signal, and to provide a data signal to the miniature transducer assembly, the data signal comprising the digital electrical signals.

40. A miniature transducer assembly according to claim 39, further comprising means for generating, from the externally generated clock signal provided on the second external terminal, a power supply signal for powering the miniature transducer assembly.

41. A miniature transducer assembly according to claim 35 comprising three external terminals.

42. A miniature transducer assembly according to claim 41, wherein a first external terminal is adapted to be connected to ground, and wherein a second external terminal is adapted to receive an externally generated clock signal, and wherein a third external terminal is adapted to provide a data signal to the miniature transducer assembly, the data signal comprising the digital electrical signals.

43. A miniature transducer assembly according to claim 42, further comprising means for generating, from the externally generated clock signal provided on the second external terminal, a power supply signal for powering the miniature transducer assembly.

44. A miniature transducer assembly according to claim 39, wherein the externally generated clock signal and the data signal are time multiplexed.

45. A miniature transducer assembly according to claim 44, wherein, when the clock signal is logic high, the data signal is inactive, and wherein, when the clock signal is logic low, the clock signal generator generating the clock signal is disabled.

46. A miniature transducer assembly according to claim 44, wherein the level of the clock signal, when it is in its high logic state, is substantially equal to the level of a power supply signal.

47. A miniature transducer assembly according to claim 44, wherein the level of the data signal, when it is in its high logic state, is substantially equal to half of the level of a power supply signal.

48. A miniature transducer assembly according to claim 35, wherein the miniature transducer assembly is a receiver suitable for integration in a hearing aid.

49. A miniature transducer assembly according to claim 35, wherein the miniature transducer assembly is a speaker suitable for integration in a cellular phone.

50. A miniature transducer assembly comprising a digital transducer arranged in a transducer assembly housing,
wherein the digital transducer comprises
a digital-to-analog converter having an input and an output terminal, the digital-to-analog converter being adapted to receive, on its input terminal, digital electrical signals, and convert the received digital electrical signals to analog electrical signals,
a transducer element for receiving the analog electrical signals, and for converting the received analog electrical signals to mechanical movements of at least part of the transducer element,
the transducer assembly further comprising a first and a second external terminal on the transducer assembly housing, the first external terminal being adapted to receive a first electrical signal, the second external terminal being adapted to receive a second and different electrical signal, the transducer assembly further comprising means for generating, from the first or the second electrical signal, a third and different electrical signal.

51. A miniature transducer assembly according to claim 50, wherein the first electrical signal is an externally generated clock signal, and wherein the second electrical signal is ground.

52. A miniature transducer assembly according to claim 51, wherein the generating means for generating the third and different electrical signal comprises rectifier means and a capacitor, and wherein the third and different signal is generated from the externally generated clock signal.

53. A miniature transducer assembly according to claim 52, wherein the rectifier means comprises a diode.

54. A miniature transducer assembly according to claim 50, wherein the generated third electrical signal powers the miniature transducer assembly.

55. A miniature transducer assembly according to claim 50, further comprising means for generating a fourth electrical signal in response to determined current consumption variations of the miniature transducer assembly.

56. A miniature transducer assembly according claim 55, wherein the fourth electrical signal is associated with the digital electrical signals to the digital-to-analog converter.

57. A miniature transducer assembly according to claim 55, wherein the generating means for generating the fourth electrical signal comprises current sensing means and a data load resistor.

58. A miniature transducer assembly according to claim 57, wherein the current sensing means comprises a resistor and a capacitor, the resistor and the capacitor being connected in parallel.

59. A miniature transducer assembly according to claim 57, wherein the current sensing means is connected to the first external terminal so as to receive an externally generated clock signal, and wherein the data load resistor is connected between the second external terminal and the input terminal of the digital-to-analog converter.

60. A miniature transducer assembly according to claim 57, wherein the current sensing means is connected to the first external terminal so as to receive an externally generated clock signal, and wherein the data load resistor is connected between the first external terminal and the input terminal of the digital-to-analog converter.

61. A miniature transducer assembly according to claim 57, wherein the current sensing means is connected between the second external terminal and ground, and wherein the data load resistor is connected between the second external terminal and the input terminal of the digital-to-analog converter.

62. A miniature transducer assembly according to claim 57, wherein the current sensing means is connected between the second external terminal and ground, and wherein the data load resistor is connected between the first external terminal and the input terminal of the digital-to-analog converter.

63. A miniature transducer assembly according to claim 50, wherein the miniature transducer assembly is a receiver suitable for integration in a hearing aid.

64. A miniature transducer assembly according to claim 50, wherein the miniature transducer assembly is a receiver suitable for integration in a cellular phone.

65. A miniature transducer assembly having a transducer assembly housing and comprising,
a transducer element,
an analog-to-digital converter having an input and an output terminal, the analog-to-digital converter being adapted to receive, on its input terminal, analog electrical signals from the transducer element, and convert the received analog electrical signals to digital electrical signals,
a digital-to-analog converter having an input and an output terminal, the digital-to-analog converter being adapted to receive, on its input terminal, digital electrical signals, and convert the received digital electrical signals to analog electrical signals, and provide the converted digital signals to the transducer element,
the miniature transducer assembly further comprising a plurality of external terminals on the transducer assembly housing in order for the miniature transducer assembly to be able to receive and transmit electrical signals to and from the miniature transducer assembly, wherein at least one of the plurality of external terminals is adapted to receive and/or transmit at least two electrical signals so as to reduce the number of external terminals on the miniature transducer assembly.

66. A miniature transducer assembly according to claim 65, further comprising means for selectively switching between a first and a second mode of operation.

67. A miniature transducer assembly according to claim 66, wherein, in the first mode of operation, the transducer element is connected to the analog-to-digital converter via the switching means.

68. A miniature transducer assembly according to claim 66, wherein, in the second mode of operation, the transducer element is connected to the digital-to-analog converter via the switching means.

69. A miniature transducer assembly according to claim 65, wherein at least one of the plurality of external terminals is adapted to provide digital electrical signals both to and from the miniature transducer assembly.
